(19) United States
(12) Patent Application Publication
(10) Pub. No.: US 2026/0084681 A1
(43) Pub. Date: Mar. 26, 2026

(54) SYSTEMS AND METHODS FOR VEHICLE SOFTWARE APPLICATION REGULATION

(71) Applicant: Steering Solutions IP Holding Corporation, Saginaw, MI (US)

(72) Inventors: Noah REINKE, Freeland, MI (US); Yash TRIVEDI, Auburn Hills, MI (US); Bruce E. LOWRIE, Freeland, MI (US)

(21) Appl. No.: 19/337,770

(22) Filed: Sep. 23, 2025

Related U.S. Application Data
(60) Provisional application No. 63/698,869, filed on Sep. 25, 2024.

(51) Int. Cl. B60W 10/20; B60W 10/18

(52) U.S. Cl. CPC B60W 10/20; B60W 10/18

(57) ABSTRACT

A method for vehicle application regulation for standard quality managed components includes: receiving at least one input signal; determining whether a value associated with the at least one input signal exceeds a corresponding value threshold; and, in response to the value associated with the at least one input signal exceeding the corresponding value threshold: saturating the value to a predetermined limit; and determining whether to calculate a signal rate; in response to determining to calculate a signal rate, calculating a signal rate based on at least one previous input signal; and generating a signal rate fault signal based on the signal rate.

### CROSS REFERENCE TO RELATED APPLICATIONS

This U.S. Non-Provisional Patent Application claims the benefit of and priority to U.S. Provisional Patent Application Ser. No. 63/698,869 filed Sep. 25, 2024, the contents of which are incorporated herein by reference in its entirety.

### TECHNICAL FIELD

This disclosure relates to steering systems, and in particular, to systems and methods for application regulation in a steering system.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically control various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a method for vehicle application regulation. The method comprises: receiving an input signal from a quality managed environment, wherein the input signal represents a control command for a vehicle control system; evaluating the input signal against predefined operational thresholds to determine if the signal falls within acceptable parameters, wherein the predefined operational thresholds are set based on normal and fault operating conditions; modifying the input signal if it exceeds the acceptable parameters by adjusting the input signal to remain within a predetermined range; calculating a rate of change for the input signal; comparing the calculated rate to predefined stability criteria, wherein the predefined stability criteria includes stable and unstable thresholds; and initiating corrective actions if the rate of change or value violates the stability criteria.

Another aspect of the disclosed embodiments includes a method for vehicle application regulation for standard quality managed components. The method includes: receiving at least one input signal; determining whether a value associated with the at least one input signal exceeds a corresponding value threshold; and, in response to the value associated with the at least one input signal exceeding the corresponding value threshold: saturating the value to a predetermined limit; and determining whether to calculate a signal rate; in response to determining to calculate a signal rate, calculating a signal rate based on at least one previous input signal; and generating a signal rate fault signal based on the signal rate.

Another aspect of the disclosed embodiments includes a system for vehicle application regulation for standard quality managed components. The system includes: a processor; and a memory including instructions that, when executed by the processor, cause the processor to: receive at least one input signal; determine whether a value associated with the at least one input signal exceeds a corresponding value threshold; and, in response to the value associated with the at least one input signal exceeding the corresponding value threshold: saturate the value to a predetermined limit; and determine whether to calculate a signal rate; in response to determining to calculate a signal rate, calculate a signal rate based on at least one previous input signal; and generate a signal rate fault signal based on the signal rate.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure FIG. 2 generally illustrates a controller according to the principles of the present disclosure.

FIGS. 3A and 3B generally illustrate a flow diagram of an application regulation process according to the principles of the present disclosure.

FIG. 4 is a flow diagram generally illustrating an application regulation method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically control various aspects of vehicle steering (e.g., including providing steering assist to an operator of the vehicle, controlling steerable wheels of the vehicle, and the like), vehicle propulsion, vehicle braking, and the like.

Typically, systems that provide application regulation (e.g., which may be referred to and/or include global output limiting) may ensure that quality managed (QM) environment components (e.g., components, such as components of a vehicle system that are classified as QM (Quality Managed), which is below the lowest ASIL rating for ISO 26262 to be used in higher safety critical systems such as ASIL D steering systems, such non-safety proven components (QM) can be used is higher safety systems (ASIL A, B, C, or D) if a Global Output Limiter, such as those described herein, is used to ensure safety metrics are verified for the QM component outputs) are adequately safeguarded by verifying the operational integrity of components and vehicle systems under development. Such systems that provide global output limiting may be adaptable to various vehicle systems, such as an EPS steering system, a SbW steering system, and the like, and may be utilized across different chassis and/or brake-by-wire applications if normal and failure operating windows or conditions are known.

Accordingly, systems and methods, such as those described herein, configured to provide software application regulation, may be desirable. In some embodiments, the systems and methods described herein may be configured to ensure the integrity and safety of motor torque commands under various conditions by using multiple checks and limitations. The systems and methods described herein may be configured to be used in any chassis application as long as the normal and fault conditions are defined.

The systems and methods described herein may be configured to operate in four phases: 1) signal value check and limit, 2) signal rate check and limit, 3) fault flag checks, and 4) blending. First, the systems and methods may be configured to verify that signal values are within predefined safe thresholds by using a saturation block and timer to ensure that values do not exceed the set limits. If the signal exceeds these limits, a ‘Signal Value Fault Flag’ is set. The high and low limits for the saturation block and timer checks may come from the same calibration values named ‘QMCmdLimHi’ and ‘QMCmdLimLo’.

Additionally, or alternatively, the systems and methods described herein may be configured to monitor the rate at which the signal changes to prevent sudden and unsafe fluctuations. For example, the previous signal command may then be used to calculate a signal rate and the signal rate may go through three checks, such as an unstable rate threshold which will scale the signal value and increment the P/N counter, a stable signal threshold which will saturate the rate and increment the P/N counter, and a zero-rate check which enables a timer. If any of these checks are detected, then the fault flag for signal rate is set.

Next, the systems and methods may be configured to determine if any fault flags are active, send a signal to indicate a fault has been detected. For example, the function may then check all fault flags and if one or more are set then a DTC (Diagnostic Trouble Code) may be set with the parameter byte being used to identify which flag(s) are set.

The systems and methods described herein may be configured to set and output a ‘GlbLmrFltDetd’ (Global Limiter Fault Detected) flag to alert any components downstream that a fault has been identified and the output is being altered.

The systems and methods may be configured to apply a blend factor that is supplied to blend the final output signal from the ‘QM Limited Input Signal’ to the ‘Input Signal’. The systems and methods may be configured to apply a final saturation block to ensure either the QM Limited Input Signal or Input Signal is within the hard limits of the systems and methods described herein.

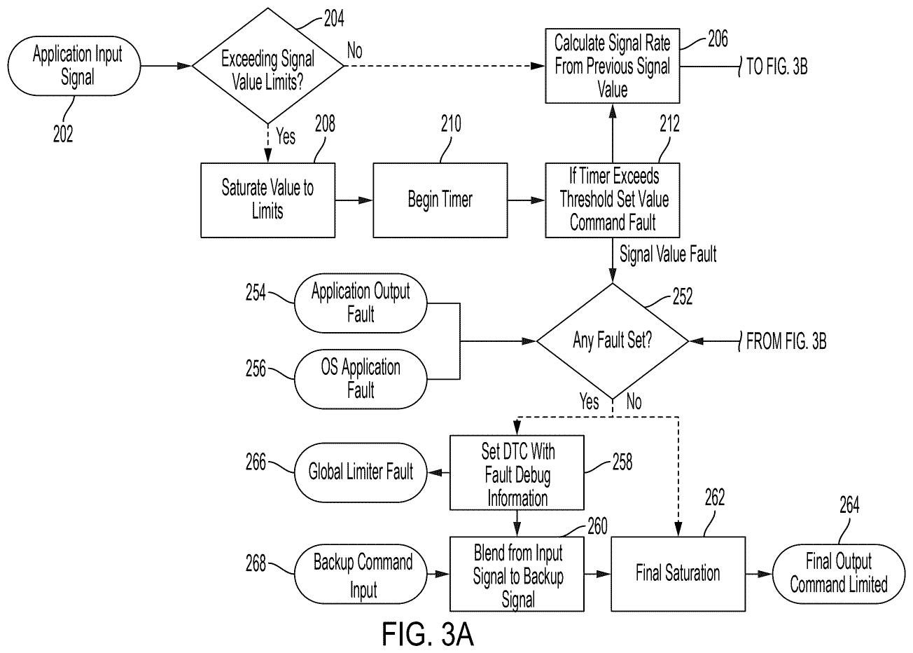

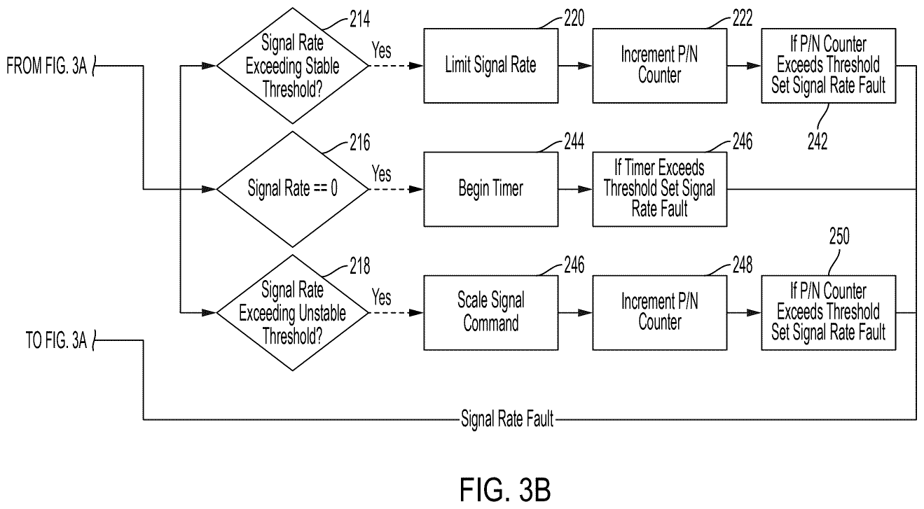

FIG. 3A and 3B generally illustrate a flow diagram of an application regulation process, according to the principles of the present disclosure. For example, an application regulation process may include receiving, at 204, an input signal from the quality managed (QM) environment and checks if this signal exceeds predefined value limits. If the signal does not exceed signal value limits, at 206, the signal rate is calculated based on previous values and three signal threshold checks are performed. If the signal does exceed signal value limits, at 208, the signal is saturated back within safe boundaries. At 210, a timer is started. Additionally, or alternatively, if the signal does not exceed the signal value limits, the time at 210 is reset.

At 212, the process determines whether the timer exceeds a threshold. If the timer exceeds the threshold, at 252, the process sets a torque command fault. If the timer does not exceed the threshold, the process continues at 206. At 206, the signal rate is calculated based on previous values and three signal threshold checks are performed. For example, at 214, the process determines whether the signal rate exceeds a stable threshold. If the signal rate does exceed the threshold, the process, at 220, limits the signal rate. At 222, the processor increments a positive/negative (P/N) counter. At 242, if the P/N counter exceeds the the threshold, the process sets a signal rate fault. If the P/N counter does not exceed the threshold, the process returns to 204. If, at 214, the signal rate does not exceed the threshold, the the process decrements the counter at 222 and returns to 204.

At 216, the process determines whether the signal rate equals 0. If the process determines that the signal rate is equals 0, the process, at 224, starts a timer. If the signal rate does not equal 0, the process stops the timer and returns to 204. At 246, if the timer exceeds a threshold, the process sets the signal rate fault.

At 218, the process determines whether the signal rate exceeds an unstable threshold. If the signal rate exceeds the unstable threshold, the process, at 246, scales a signal command.

At 248, the process increments a P/N counter. At 250, if the P/N counter exceeds a threshold, the process sets the signal rate fault. If, at 216, the signal rate does not exceed the unstable threshold, the process decrements the counter at 250, and returns to 204.

At 252, the process receives fault input data from 254 and application fault input from 256 (e.g., and/or from 212, 242, 246, and 250). The process determines whether any fault is set. If no fault is set, the process ends. If at least one fault is set, the process, at 258 sets, at 266, a global limiter fault. The process sets the DTC with debug information. At 260, the process receives, from 268, a backup command input. The process blends the command signal with the command input. At 262, the process provides final saturation. At 264, the process outputs a final output command limited signal.

A failure to maintain a stable signal may trigger a fault. The application regulation process may monitor for different types of faults, such as those related to signal values, rate thresholds, or external inputs from the QM environment. If any fault is detected, the application regulation process sets a “Global Limiter Fault,” which involves setting an DTC with fault debugging information. The application regulation process may blend the customer signal with a “Backup Command Input” signal. The output command is then limited to ensure the integrity and safety of the system.

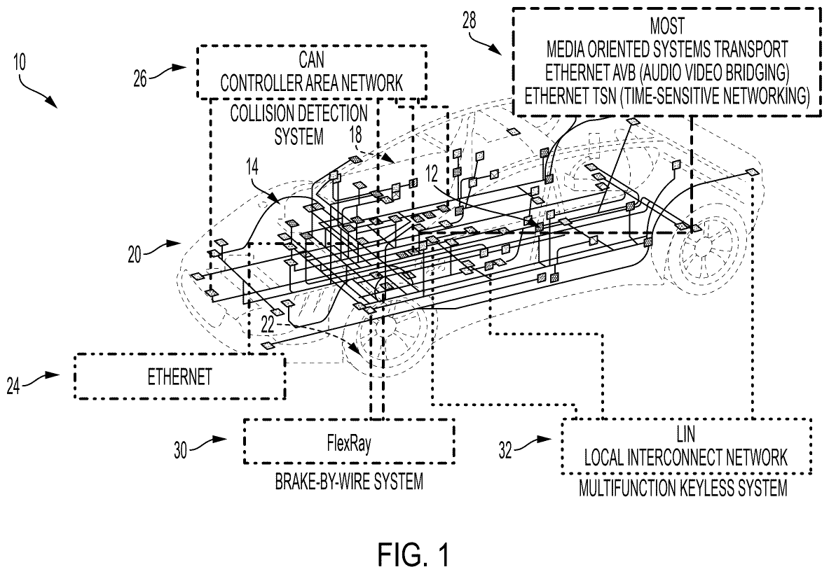

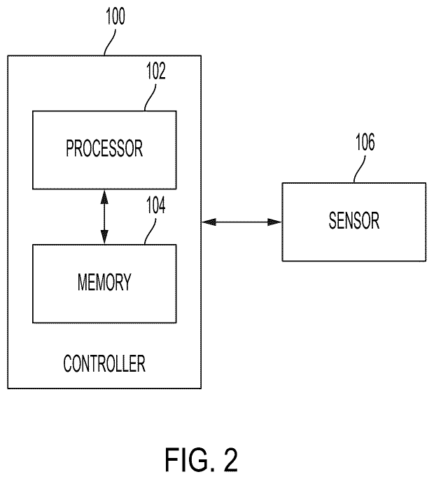

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10.

The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to receive an input signal from a quality managed environment. The input signal may represent a control command for a vehicle control system. The controller 100 may evaluate the input signal against predefined operational thresholds to determine whether the signal falls within acceptable parameters. The predefined operational thresholds may be set based on normal and/or fault operating conditions.

The controller 100 may modify the input signal based on a determination that the input signal exceeds the acceptable parameters. For example, the controller 100 may adjust the input signal to remain within a predetermined range. The controller 100 may calculate a rate of change for the input signal.

The controller 100 may compare the calculated rate to predefined stability criteria. The predefined stability criteria may include stable and unstable thresholds. The controller 100 may initiate corrective actions in response to a determination that the rate of change violates the stability criteria.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

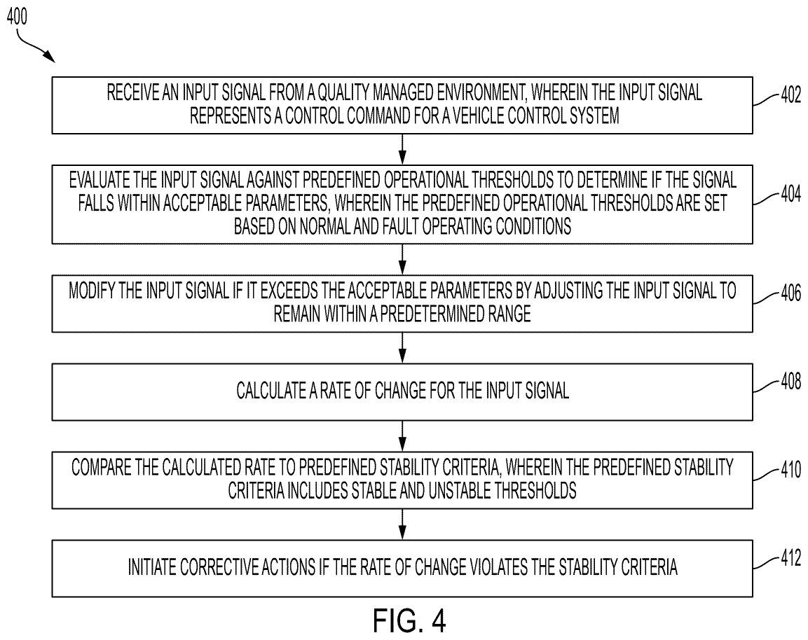

FIG. 4 is a flow diagram generally illustrating an application regulation method 400 according to the principles of the present disclosure. At 402, the method 400 receives an input signal from a quality managed environment. The input signal may represent a control command for a vehicle control system.

At 404, the method 400 evaluates the input signal against predefined operational thresholds to determine whether the signal falls within acceptable parameters. The predefined operational thresholds may be set based on normal and fault operating conditions.

At 406, the method 400 modifies the input signal based on a determination that the input signal exceeds the acceptable parameters. For example, the method 400 adjusts the input signal to remain within a predetermined range.

At 408, the method 400 calculates a rate of change for the input signal.

At 410, the method 400 compares the calculated rate to predefined stability criteria. The predefined stability criteria may include stable and unstable thresholds.

At 412, the method 400 initiates corrective actions based on a determination that the rate of change violates the stability criteria and/or the value violates the value threshold.

In some embodiments, a method for vehicle application regulation comprises: receiving an input signal from a quality managed environment, wherein the input signal represents a control command for a vehicle control system; evaluating the input signal against predefined operational thresholds to determine if the signal falls within acceptable parameters, wherein the predefined operational thresholds are set based on normal and fault operating conditions; modifying the input signal if it exceeds the acceptable parameters by adjusting the input signal to remain within a predetermined range; calculating a rate of change for the input signal; comparing the calculated rate to predefined stability criteria, wherein the predefined stability criteria includes stable and unstable thresholds; and initiating corrective actions if the rate of change violates the stability criteria and/or the value violates the value thresholds.

In some embodiments, a system for vehicle application regulation comprise a processor; and a memory including instructions that, when executed by the processor, cause the processor to: receive an input signal from a quality managed environment, wherein the input signal represents a control command for a vehicle control system; evaluate the input signal against predefined operational thresholds to determine if the signal falls within acceptable parameters, wherein the predefined operational thresholds are set based on normal and fault operating conditions; modify the input signal if it exceeds the acceptable parameters by adjusting the input signal to remain within a predetermined range; calculate a rate of change for the input signal; compare the calculated rate to predefined stability criteria, wherein the predefined stability criteria includes stable and unstable thresholds; and initiate corrective actions if the rate of change violates the stability criteria and/or the value violates the value thresholds.

In some embodiments, a method for vehicle application regulation for standard quality managed components includes: receiving at least one input signal; determining whether a value associated with the at least one input signal exceeds a corresponding value threshold; and, in response to the value associated with the at least one input signal exceeding the corresponding value threshold: saturating the value to a predetermined limit; and determining whether to calculate a signal rate; in response to determining to calculate a signal rate, calculating a signal rate based on at least one previous input signal; and generating a signal rate fault signal based on the signal rate.

In some embodiments, the at least one input signal is associated with a standard quality managed component. In some embodiments, the standard quality managed component includes a component of a vehicle system. In some embodiments, the vehicle system includes a vehicle steering system. In some embodiments, the vehicle system includes a chassis system. In some embodiments, the vehicle system includes a brake-by-wire system. In some embodiments, the at least one input signal represents a control command associated with the vehicle system. In some embodiments, the method also includes, in response to the value associated with the at least one input signal not exceeding the corresponding value threshold: calculating the signal rate based on at least one previous input signal; and generating the signal rate fault signal based on the signal rate. In some embodiments, generating the signal rate fault signal based on the signal rate includes: determining whether the signal rate exceeds a stable threshold; in response to a determination that the signal rate exceeds the stable threshold, increment a counter; and, in response to a counter value of the counter exceeding a counter value threshold, generating the signal rate fault signal. In some embodiments, generating the signal rate fault signal based on the signal rate includes: determining whether the signal rate equals 0; in response to a determination that the signal equals 0, begin a timer; and, in response to a timer value of the timer exceeding a timer value threshold, generating the signal rate fault signal. In some embodiments, generating the signal rate fault signal based on the signal rate includes: determining whether the signal rate exceeds an unstable threshold; in response to a determination that the signal rate exceeds the unstable threshold, increment a counter; and, in response to a counter value of the counter exceeding a counter value threshold, generating the signal rate fault signal. In some embodiments, in response to the signal rate fault signal: setting a diagnostic trouble code with fault debug information; generating a blended signal by blending the at least one input signal with at least one backup signal; and saturating the blended signal.

In some embodiments, a system for vehicle application regulation for standard quality managed components includes: a processor; and a memory including instructions that, when executed by the processor, cause the processor to: receive at least one input signal; determine whether a value associated with the at least one input signal exceeds a corresponding value threshold; and, in response to the value associated with the at least one input signal exceeding the corresponding value threshold: saturate the value to a predetermined limit; and determine whether to calculate a signal rate; in response to determining to calculate a signal rate, calculate a signal rate based on at least one previous input signal; and generate a signal rate fault signal based on the signal rate.

In some embodiments, the at least one input signal is associated with a standard quality managed component. In some embodiments, the standard quality managed component includes a component of a vehicle system. In some embodiments, the vehicle system includes a vehicle steering system. In some embodiments, the vehicle system includes a chassis system. In some embodiments, the vehicle system includes a brake-by-wire system. In some embodiments, the at least one input signal represents a control command associated with the vehicle system. In some embodiments, the instructions further cause the processor to, in response to the value associated with the at least one input signal not exceeding the corresponding value threshold: calculate the signal rate based on at least one previous input signal; and generate the signal rate fault signal based on the signal rate.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal”and “data”are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for application regulation for standard quality managed components, the method comprising:
receiving at least one input signal;
determining whether a value associated with the at least one input signal exceeds a corresponding value threshold; and
in response to the value associated with the at least one input signal exceeding the corresponding value threshold:
saturating the value to a predetermined limit; and
determining whether to calculate a signal rate;
in response to determining to calculate a signal rate, calculating a signal rate based on at least one previous input signal; and
generating a signal rate fault signal based on the signal rate.

2. The method of claim 1, wherein the at least one input signal is associated with a standard quality managed component.

3. The method of claim 2, wherein the standard quality managed component includes a component of a vehicle system.

4. The method of claim 3, wherein the vehicle system includes a vehicle steering system.

5. The method of claim 3, wherein the vehicle system includes a chassis system.

6. The method of claim 3, wherein the vehicle system includes a brake-by-wire system.

7. The method of claim 3, wherein the at least one input signal represents a control command associated with the vehicle system.

8. The method of claim 1, further comprising, in response to the value associated with the at least one input signal not exceeding the corresponding value threshold:
calculating the signal rate based on at least one previous input signal; and
generating the signal rate fault signal based on the signal rate.

9. The method of claim 1, wherein generating the signal rate fault signal based on the signal rate includes:
determining whether the signal rate exceeds a stable threshold;
in response to a determination that the signal rate exceeds the stable threshold, increment a counter; and
in response to a counter value of the counter exceeding a counter value threshold, generating the signal rate fault signal.

10. The method of claim 1, wherein generating the signal rate fault signal based on the signal rate includes:
determining whether the signal rate equals 0;
in response to a determination that the signal equals 0, begin a timer; and
in response to a timer value of the timer exceeding a timer value threshold, generating the signal rate fault signal.

11. The method of claim 1, wherein generating the signal rate fault signal based on the signal rate includes:
determining whether the signal rate exceeds an unstable threshold;
in response to a determination that the signal rate exceeds the unstable threshold, increment a counter; and
in response to a counter value of the counter exceeding a counter value threshold, generating the signal rate fault signal.

12. The method of claim 1, in response to the signal rate fault signal:
setting a diagnostic trouble code with fault debug information;
generating a blended signal by blending the at least one input signal with at least one other signal; and
saturating the blended signal.

13. A system for application regulation for standard quality managed components, the system comprising:
a processor; and
a memory including instructions that, when executed by the processor, cause the processor to:
receive at least one input signal;
determine whether a value associated with the at least one input signal exceeds a corresponding value threshold; and
in response to the value associated with the at least one input signal exceeding the corresponding value threshold:
saturate the value to a predetermined limit; and
determine whether to calculate a signal rate;
in response to determining to calculate a signal rate, calculate a signal rate based on at least one previous input signal; and
generate a signal rate fault signal based on the signal rate.

14. The system of claim 13, wherein the at least one input signal is associated with a standard quality managed component.

15. The system of claim 14, wherein the standard quality managed component includes a component of a vehicle system.

16. The system of claim 15, wherein the vehicle system includes a vehicle steering system.

17. The system of claim 15, wherein the vehicle system includes a chassis system.

18. The system of claim 15, wherein the vehicle system includes a brake-by-wire system.

19. The system of claim 15, wherein the at least one input signal represents a control command associated with the vehicle system.

20. The system of claim 13, wherein the instructions further cause the processor to, in response to the value associated with the at least one input signal not exceeding the corresponding value threshold:
calculate the signal rate based on at least one previous input signal; and
generate the signal rate fault signal based on the signal rate.
